(19) United States
(12) Patent Application Publication
(10) Pub. No.: US 2022/0308204 A1
(43) Pub. Date: Sep. 29, 2022

(54) BEAM STEERING RADAR WITH SELECTIVE SCANNING MODE FOR AUTONOMOUS VEHICLES

(71) Applicant: Metawave Corporation, Carlsbad, CA (US)

(72) Inventor: Abdullah Ahsan Zaidi, San Diego, CA (US)

(21) Appl. No.: 17/619,905

(22) PCT Filed: Jul. 2, 2020
(86) PCT No.: PCT/US2020/040768

§ 371 Date: Dec. 16, 2021

Related U.S. Application Data
(60) Provisional application No. 62/869,913, filed on Jul. 2, 2019.

(51) Int. Cl. G01S 13/931; G01S 13/58; G05B 13/02; B60W 60/00; H01Q 1/32

(52) U.S. Cl. CPC G01S 13/931; G01S 13/58; G05B 13/0265; B60W 60/001; H01Q 1/3233; B60W 2420/52

(57) ABSTRACT

Examples disclosed herein relate to a beam steering radar for use in an autonomous vehicle. The beam steering radar has a radar module with at least one beam steering antenna, a transceiver, and a controller that can cause the transceiver to perform, using the at least one beam steering antenna, a first scan of a first field-of-view (FoV) with a first chirp slope in a first radio frequency (RF) signal and a second scan of a second FoV with a second chirp slope in a second RF signal. The radar module also has a perception module having a machine learning-trained classifier that can detect objects in a path and surrounding environment of the autonomous vehicle based on the first chirp slope in the first RF signal and classify the objects based on the second chirp slope in the second RF signal.

### CROSS REFERENCE TO RELATED APPLICATIONS

This application claims priority to U.S. Prov. Appl. No. 62/869,913, titled “BEAM STEERING RADAR WITH A SELECTIVE SCANNING MODE FOR USE IN AUTONOMOUS VEHICLES,” filed on Jul. 2, 2019, which is incorporated by reference herein in its entirety.

### BACKGROUND

Autonomous driving is quickly moving from the realm of science fiction to becoming an achievable reality. Already in the market are Advanced-Driver Assistance Systems (“ADAS”) that automate, adapt and enhance vehicles for safety and better driving. The next step will be vehicles that increasingly assume control of driving functions such as steering, accelerating, braking and monitoring the surrounding environment and driving conditions to respond to events, such as changing lanes or speed when needed to avoid traffic, crossing pedestrians, animals, and so on. The requirements for object and image detection are critical and specify the time required to capture data, process it and turn it into action. All this while ensuring accuracy, consistency and cost optimization.

An aspect of making this work is the ability to detect and classify objects in the surrounding environment at the same or possibly even better level as humans. Humans are adept at recognizing and perceiving the world around them with an extremely complex human visual system that essentially has two main functional parts: the eye and the brain. In autonomous driving technologies, the eye may include a combination of multiple sensors, such as camera, radar, and lidar, while the brain may involve multiple artificial intelligence, machine learning and deep learning systems. The goal is to have full understanding of a dynamic, fast-moving environment in real time and human-like intelligence to act in response to changes in the environment.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates an example environment in which a beam steering radar with a selective scanning mode in an autonomous vehicle is used to detect and identify objects;

FIG. 2 is a schematic diagram of an autonomous driving system for an autonomous vehicle in accordance with various examples;

FIG. 3 is a schematic diagram of a beam steering radar system as in FIG. 2 in accordance with various examples;

FIG. 4 illustrates an example environment in which a beam steering radar implemented as in FIG. 3 operates in a selective scanning mode;

FIG. 5 illustrates the antenna elements of the receive and guard antennas of FIG. 3 in more detail in accordance with various examples;

FIG. 6 illustrates an example radar signal and its associated scan parameters in more detail;

FIG. 7 is a flowchart of an example process for operating a beam steering radar in an adjustable long-range mode in accordance with various examples; and

FIG. 8 illustrates an example radar beam transmitted by a beam steering radar implemented as in FIG. 3 and in accordance with various examples.

### DETAILED DESCRIPTION

A beam steering radar with a selective scanning mode for use in autonomous vehicles is disclosed. The beam steering radar incorporates at least one beam steering antenna that is dynamically controlled such as to change its electrical or electromagnetic configuration to enable beam steering. The beam steering antenna generates a narrow, directed beam that can be steered to any angle (i.e., from 0° to 360°) across a field-of-view (“FoV”) to detect objects. In various examples, the beam steering radar operates in a selective scanning mode to scan around an area of interest. The beam steering radar can steer to a desired angle and then scan around that angle to detect objects in the area of interest without wasting any processing or scanning cycles illuminating areas with no valid objects. The dynamic control is implemented with processing engines which upon identifying objects in the vehicle's FoV, inform the beam steering radar where to steer its beams and focus on the areas and objects of interest by adjusting its radar scan parameters. The objects of interest may include structural elements in the vehicle's FoV such as roads, walls, buildings and road center medians, as well as other vehicles, pedestrians, bystanders, cyclists, plants, trees, animals and so on.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

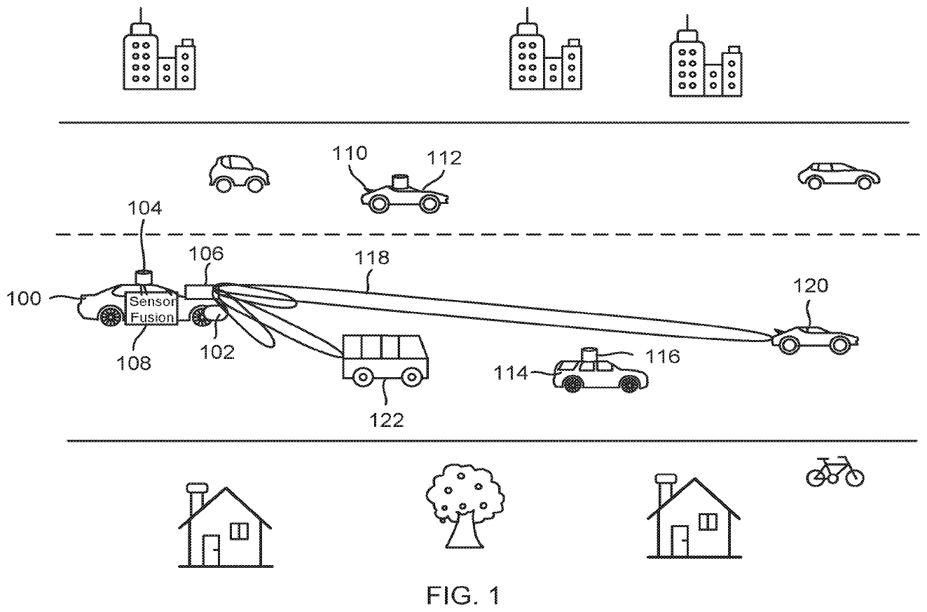

FIG. 1 illustrates an example environment in which a beam steering radar with a selective scanning mode in an autonomous vehicle is used to detect and identify objects. Ego vehicle 100 is an autonomous vehicle with a beam steering radar system 106 for transmitting a radar signal to scan a FoV or specific area. As described in more detail below, the radar signal is transmitted according to a set of scan parameters that can be adjusted to result in multiple transmission beams 118. The scan parameters may include, among others, the total angle of the scanned area defining the FoV, the beam width or the scan angle of each incremental transmission beam, the number of chirps in the radar signal, the chirp time, the chirp segment time, the chirp slope, and so on. The entire FoV or a portion of it can be scanned by a compilation of such transmission beams 118, which may be in successive adjacent scan positions or in a specific or random order. Note that the term FoV is used herein in reference to the radar transmissions and does not imply an optical FoV with unobstructed views. The scan parameters may also indicate the time interval between these incremental transmission beams, as well as start and stop angle positions for a full or partial scan.

In various examples, the ego vehicle 100 may also have other perception sensors such as camera 102 and lidar 104. These perception sensors are not required for the ego vehicle 100, but may be useful in augmenting the object detection capabilities of the beam steering radar 106. Camera sensor 102 may be used to detect visible objects and conditions and to assist in the performance of various functions. The lidar sensor 104 can also be used to detect objects and provide this information to adjust control of the vehicle. This information may include information such as congestion on a highway, road conditions, and other conditions that would impact the sensors, actions or operations of the vehicle. Camera sensors are currently used in Advanced Driver Assistance Systems (“ADAS”) to assist drivers in driving functions such as parking (e.g., in rear view cameras). Cameras can capture texture, color and contrast information at a high level of detail, but similar to the human eye, they are susceptible to adverse weather conditions and variations in lighting. Camera 102 may have a high resolution but cannot resolve objects beyond 50 meters.

Lidar sensors typically measure the distance to an object by calculating the time taken by a pulse of light to travel to an object and back to the sensor. When positioned on top of a vehicle, a lidar sensor can provide a 360° 3D view of the surrounding environment. Other approaches may use several lidars at different locations around the vehicle to provide the full 360° view. However, lidar sensors such as lidar 104 are still prohibitively expensive, bulky in size, sensitive to weather conditions and are limited to short ranges (typically <150-200 meters). Radars, on the other hand, have been used in vehicles for many years and operate in all-weather conditions. Radars also use far less processing than the other types of sensors and have the advantage of detecting objects behind obstacles and determining the speed of moving objects. When it comes to resolution, lidars' laser beams are focused on small areas, have a smaller wavelength than RF signals, and can achieve around 0.25 degrees of resolution.

In various examples and as described in more detail below, the beam steering radar 106 can provide a 360° true 3D vision and human-like interpretation of the ego vehicle's path and surrounding environment. The beam steering radar 106 is capable of shaping and steering RF beams in all directions in a 360° FoV with at least one beam steering antenna and recognize objects quickly and with a high degree of accuracy over a long range of around 300 meters or more. The short-range capabilities of camera 102 and lidar 104 along with the long-range capabilities of radar 106 enable a sensor fusion module 108 in ego vehicle 100 to enhance its object detection and identification.

As illustrated, beam steering radar 106 is capable of detecting both vehicle 120 at a far range (e.g., >250 m) as well as bus 122 at a short range (e.g., <100 m). Detecting both in a short amount of time and with enough range and velocity resolution is imperative for full autonomy of driving functions of the ego vehicle. Radar 106 has an adjustable long-range radar (“LRR”) mode that enables the detection of long-range objects in a very short time to then focus on obtaining finer velocity resolution for the detected vehicles. Although not described herein, radar 106 is capable of time-alternatively reconfiguring between LRR and short-range radar (“SRR”) modes. The SRR mode enables a wide beam with lower gain, but can make quick decisions to avoid an accident, assist in parking and downtown travel, and capture information about a broad area of the environment. The LRR mode enables a narrow, directed beam and long distance, having high gain; this is powerful for high speed applications, and where longer processing time allows for greater reliability. The adjustable LRR mode uses a reduced number of chirps (e.g., 5, 10, 15, or 20) to reduce the chirp segment time by up to 75%, guaranteeing a fast beam scanning rate that is critical for successful object detection and autonomous vehicle performance. Excessive dwell time for each beam position may cause blind zones, and the adjustable LRR mode ensures that fast object detection can occur at long range while maintaining the antenna gain, transmit power and desired SNR for the radar operation.

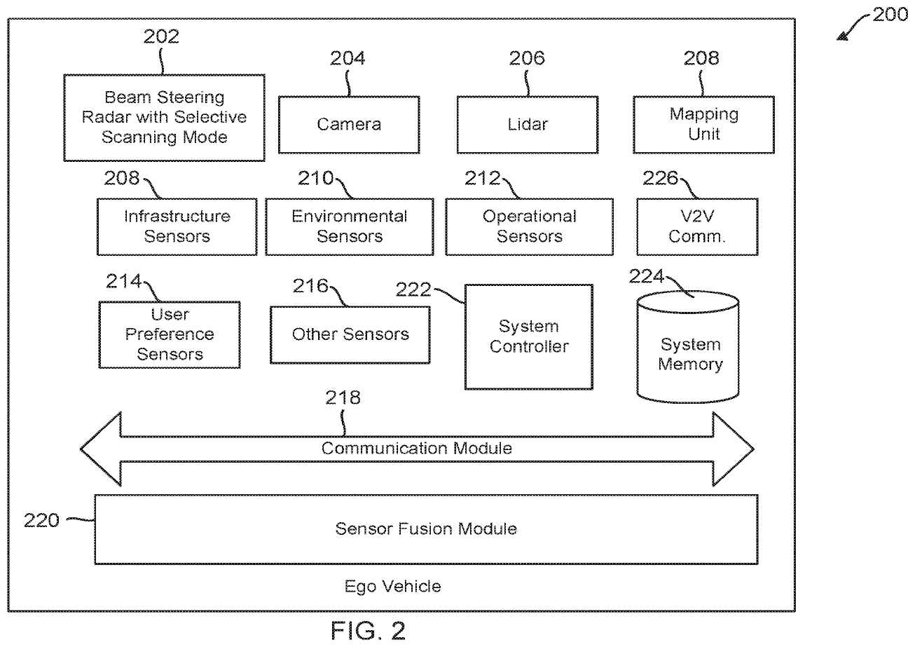

Attention is now directed to FIG. 2, which illustrates a schematic diagram of an autonomous driving system for an ego vehicle in accordance with various examples. Autonomous driving system 200 is a system for use in an ego vehicle that provides some or full automation of driving functions. The driving functions may include, for example, steering, accelerating, braking, and monitoring the surrounding environment and driving conditions to respond to events, such as changing lanes or speed when needed to avoid traffic, crossing pedestrians, animals, and so on. The autonomous driving system 200 includes a beam steering radar system 202 and other sensor systems such as camera 204, lidar 206, infrastructure sensors 208, environmental sensors 210, operational sensors 212, user preference sensors 214, and other sensors 216. Autonomous driving system 200 also includes a communications module 218, a sensor fusion module 220, a system controller 222, a system memory 224, and a vehicle-to-vehicle (V2V) communications module 226. It is appreciated that this configuration of autonomous driving system 200 is an example configuration and not meant to be limiting to the specific structure illustrated in FIG. 2. Additional systems and modules not shown in FIG. 2 may be included in autonomous driving system 200.

In various examples, beam steering radar 202 with adjustable LRR mode includes at least one beam steering antenna for providing dynamically controllable and steerable beams that can focus on one or multiple portions of a 360° FoV of the vehicle. The beams radiated from the beam steering antenna are reflected back from objects in the vehicle's path and surrounding environment and received and processed by the radar 202 to detect and identify the objects. Radar 202 includes a perception module that is trained to detect and identify objects and control the radar module as desired. Camera sensor 204 and lidar 206 may also be used to identify objects in the path and surrounding environment of the ego vehicle, albeit at a much lower range.

Infrastructure sensors 208 may provide information from infrastructure while driving, such as from a smart road configuration, bill board information, traffic alerts and indicators, including traffic lights, stop signs, traffic warnings, and so forth. This is a growing area, and the uses and capabilities derived from this information are immense. Environmental sensors 210 detect various conditions outside, such as temperature, humidity, fog, visibility, precipitation, among others. Operational sensors 212 provide information about the functional operation of the vehicle. This may be tire pressure, fuel levels, brake wear, and so forth. The user preference sensors 214 may be configured to detect conditions that are part of a user preference. This may be temperature adjustments, smart window shading, etc. Other sensors 216 may include additional sensors for monitoring conditions in and around the vehicle.

In various examples, the sensor fusion module 220 optimizes these various functions to provide an approximately comprehensive view of the vehicle and environments. Many types of sensors may be controlled by the sensor fusion module 220. These sensors may coordinate with each other to share information and consider the impact of one control action on another system. In one example, in a congested driving condition, a noise detection module (not shown) may identify that there are multiple radar signals that may interfere with the vehicle. This information may be used by a perception module in radar 202 to adjust the radar's scan parameters so as to avoid these other signals and minimize interference.

In another example, environmental sensor 210 may detect that the weather is changing, and visibility is decreasing. In this situation, the sensor fusion module 220 may determine to configure the other sensors to improve the ability of the vehicle to navigate in these new conditions. The configuration may include turning off camera or lidar sensors 204-206 or reducing the sampling rate of these visibility-based sensors. This effectively places reliance on the sensor(s) adapted for the current situation. In response, the perception module configures the radar 202 for these conditions as well. For example, the radar 202 may reduce the beam width to provide a more focused beam, and thus a finer sensing capability.

In various examples, the sensor fusion module 220 may send a direct control to radar 202 based on historical conditions and controls. The sensor fusion module 220 may also use some of the sensors within system 200 to act as feedback or calibration for the other sensors. In this way, an operational sensor 212 may provide feedback to the perception module and/or the sensor fusion module 220 to create templates, patterns and control scenarios. These are based on successful actions or may be based on poor results, where the sensor fusion module 220 learns from past actions.

Data from sensors 202-216 may be combined in sensor fusion module 220 to improve the target detection and identification performance of autonomous driving system 200. Sensor fusion module 220 may itself be controlled by system controller 222, which may also interact with and control other modules and systems in the vehicle. For example, system controller 222 may turn the different sensors 202-216 on and off as desired, or provide instructions to the vehicle to stop upon identifying a driving hazard (e.g., deer, pedestrian, cyclist, or another vehicle suddenly appearing in the vehicle's path, flying debris, etc.).

All modules and systems in autonomous driving system 200 communicate with each other through communication module 218. Autonomous driving system 200 also includes system memory 224, which may store information and data (e.g., static and dynamic data) used for operation of system 200 and the ego vehicle using system 200. V2V communications module 226 is used for communication with other vehicles. The V2V communications may also include information from other vehicles that is invisible to the user, driver, or rider of the vehicle, and may help vehicles coordinate to avoid an accident. Mapping unit 228 may provide mapping and location data for the vehicle, which alternatively may be stored in system memory 224. In various examples, the mapping and location data may be used in a selective scanning mode of operation of beam steering radar 202 to focus the beam steering around an angle of interest when the ego vehicle is navigating a curved road. In other examples, the mapping and location data may be used in the selective scanning mode of operation of beam steering radar 202 to focus the beam steering for a reduced range with higher range resolution (albeit with a smaller maximum velocity) in a city street environment or focus the beam steering for an increased range with higher maximum velocity (albeit with a larger range resolution) in a highway environment.

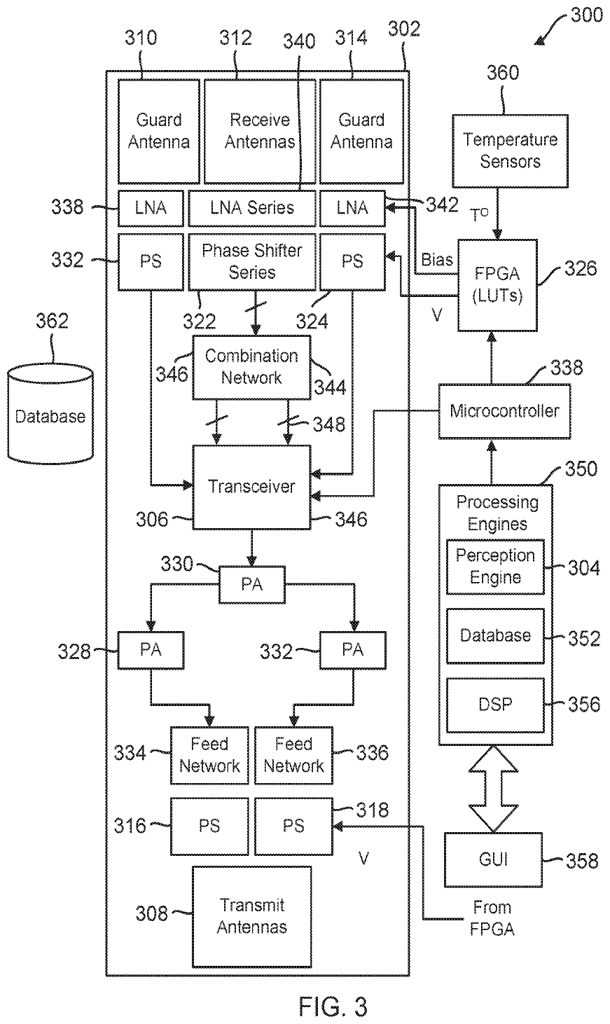

FIG. 3 illustrates a schematic diagram of a beam steering radar system with a selective scanning mode as in FIG. 2 in accordance with various examples. Beam steering radar 300 is a “digital eye” with true 3D vision and capable of a human-like interpretation of the world. The “digital eye” and human-like interpretation capabilities are provided by two main modules: radar module 302 and a perception engine 304. Radar module 302 is capable of both transmitting RF signals within a FoV and receiving the reflections of the transmitted signals as they reflect off of objects in the FoV. With the use of analog beamforming in radar module 302, a single transmit and receive chain can be used effectively to form a directional, as well as a steerable, beam. A transceiver 306 in radar module 302 is adapted to generate signals for transmission through a series of transmit antennas 308 as well as manage signals received through a series of receive antennas 310-314. Beam steering within the FoV is implemented with phase shifter (“PS”) circuits 316-318 coupled to the transmit antennas 308 on the transmit chain and PS circuits 320-324 coupled to the receive antennas 310-314 on the receive chain, respectively.

The use of PS circuits 316-318 and 320-324 enables separate control of the phase of each element in the transmit and receive antennas. Unlike early passive architectures, the beam is steerable not only to discrete angles but to any angle (i.e., from 0° to 360°) within the FoV using active beamforming antennas. A multiple element antenna can be used with an analog beamforming architecture where the individual antenna elements may be combined or divided at the port of the single transmit or receive chain without additional hardware components or individual digital processing for each antenna element. Further, the flexibility of multiple element antennas allows narrow beam width for transmit and receive. The antenna beam width decreases with an increase in the number of antenna elements. A narrow beam improves the directivity of the antenna and provides the radar 300 with a significantly longer detection range.

The major challenge with implementing analog beam steering is to design PSs to operate at 77 GHz. PS circuits 316-318 and 320-324 solve this problem with a reflective PS design implemented with a distributed varactor network currently built using Gallium-Arsenide (GaAs) materials. Each PS circuit 316-318 and 320-324 has a series of PSs, with each PS coupled to an antenna element to generate a phase shift value of anywhere from 0° to 360° for signals transmitted or received by the antenna element. The PS design is scalable in future implementations to Silicon-Germanium (SiGe) and complementary metal-oxide semiconductors (CMOS), bringing down the PS cost to meet specific demands of customer applications. Each PS circuit 316-318 and 320-324 is controlled by a Field Programmable Gate Array (“FPGA”) 326, which provides a series of voltages to the PSs in each PS circuit that results in a series of phase shifts.

In various examples, a voltage value is applied to each PS in the PS circuits 316-318 and 320-324 to generate a given phase shift and provide beam steering. The voltages applied to the PSs in PS circuits 316-318 and 320-324 are stored in Look-up Tables (“LUTs”) in the FPGA 306. These LUTs are generated by an antenna calibration process that determines which voltages to apply to each PS to generate a given phase shift under each operating condition. Note that the PSs in PS circuits 316-318 and 320-324 are capable of generating phase shifts at a very high resolution of less than one degree. This enhanced control over the phase allows the transmit and receive antennas in radar module 302 to steer beams with a very small step size, improving the capability of the radar 300 to resolve closely located targets at small angular resolution.

In various examples, the transmit antennas 308 and the receive antennas 310-314 may be a meta-structure antenna, a phase array antenna, or any other antenna capable of radiating RF signals in millimeter wave frequencies. A meta-structure, as generally defined herein, is an engineered structure capable of controlling and manipulating incident radiation at a desired direction based on its geometry. Various configurations, shapes, designs and dimensions of the antennas 308-314 may be used to implement specific designs and meet specific constraints.

The transmit chain in radar 300 starts with the transceiver 306 generating RF signals to prepare for transmission over-the-air by the transmit antennas 308. The RF signals may be, for example, Frequency-Modulated Continuous Wave (“FMCW”) signals. An FMCW signal enables the radar 300 to determine both the range to an object and the object's velocity by measuring the differences in phase or frequency between the transmitted signals and the received/reflected signals or echoes. Within FMCW formats, there are a variety of waveform patterns that may be used, including sinusoidal, triangular, sawtooth, rectangular and so forth, each having advantages and purposes.

Once the FMCW signals are generated by the transceiver 306, they are provided to power amplifiers (“PAs”) 328-332. Signal amplification is needed for the FMCW signals to reach the long ranges desired for object detection, as the signals attenuate as they radiate by the transmit antennas 308. From the PAs 328-332, the signals are divided and distributed through feed networks 334-336, which form a power divider system to divide an input signal into multiple signals, one for each element of the transmit antennas 308. The feed networks 334-336 may divide the signals so power is equally distributed among them, or alternatively, so power is distributed according to another scheme, in which the divided signals do not all receive the same power. Each signal from the feed networks 334-336 is then input into a PS in PS circuits 316-318, where they are phase shifted based on voltages generated by the FPGA 326 under the direction of microcontroller 338 and then transmitted through transmit antennas 308.

Microcontroller 338 determines which phase shifts to apply to the PSs in PS circuits 316-318 according to a desired scanning mode based on road and environmental scenarios. Microcontroller 338 also determines the scan parameters for the transceiver to apply at its next scan. The scan parameters may be determined at the direction of one of the processing engines 350, such as at the direction of perception engine 304. Depending on the objects detected, the perception engine 304 may instruct the microcontroller 338 to adjust the scan parameters at a next scan to focus on a given area of the FoV or to steer the beams to a different direction.

In various examples and as described in more detail below, radar 300 operates in one of various modes, including a full scanning mode and a selective scanning mode, among others. In a full scanning mode, both transmit antennas 308 and receive antennas 310-314 scan a complete FoV with small incremental steps. Even though the FoV may be limited by system parameters due to increased side lobes as a function of the steering angle, radar 300 can detect objects over a significant area for a long-range radar. The range of angles to be scanned on either side of boresight as well as the step size between steering angles/phase shifts can be dynamically varied based on the driving environment. To improve performance of an autonomous vehicle (e.g., an ego vehicle) driving through an urban environment, the scan range can be increased to keep monitoring the intersections and curbs to detect vehicles, pedestrians or bicyclists. This wide scan range may deteriorate the frame rate (revisit rate), but is considered acceptable as the urban environment generally involves low velocity driving scenarios. For a high-speed freeway scenario, where the frame rate is critical, a higher frame rate can be maintained by reducing the scan range. In this case, a few degrees of beam scanning on either side of the boresight would suffice for long-range target detection and tracking.

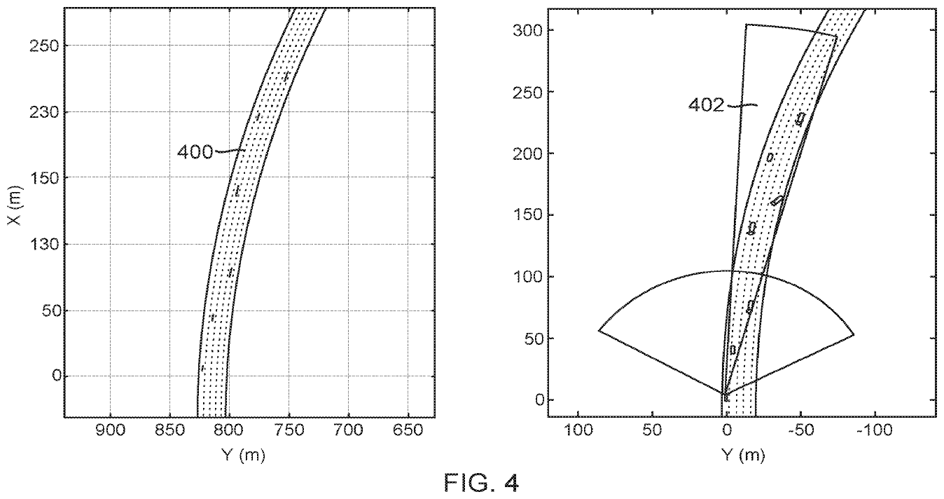

In a selective scanning mode, the radar 300 scans around an area of interest by steering to a desired angle and then scanning around that angle. This ensures the radar 300 is to detect objects in the area of interest without wasting any processing or scanning cycles illuminating areas with no valid objects. One of the scenarios in which such scanning is useful is in the case of a curved freeway or road as illustrated in FIG. 4. Since the radar 300 can detect objects at a long distance, e.g., 300 m or more at boresight, if there is a curve in a road such as road 400, direct measures do not provide helpful information. Rather, the radar 300 steers along the curvature of the road, as illustrated with beam area 402. The radar 300 may acquire mapping and location data from a database or mapping unit in the vehicle (e.g., mapping unit 228 of FIG. 2) to know when a curved road will appear so the radar 300 can activate the selective scanning mode. Similarly in other use cases, the mapping and location data can be used to detect a change in the path and/or surrounding environment, such as a city street environment or a highway environment, where the maximum range needed for object detection may vary depending on the detected environment (or path). For example, the mapping and location data may be used in the selective scanning mode of operation of radar 300 to focus the beam steering for a reduced range with higher range resolution (albeit with a smaller maximum velocity) in a city street environment or focus the beam steering for an increased range with higher maximum velocity (albeit with a larger range resolution) in a highway environment.

This selective scanning mode is more efficient, as it allows the radar 300 to align its beams towards the area of interest rather than waste any scanning on areas without objects or useful information to the vehicle. In various examples, the selective scanning mode is implemented by changing the chirp slope of the FMCW signals generated by the transceiver 306 and by shifting the phase of the transmitted signals to the steering angles needed to cover the curvature of the road 400.

Returning to FIG. 3, objects are detected with radar 300 by reflections or echoes that are received at the series of receive antennas 310-314, which are directed by PS circuits 320-324. Low Noise Amplifiers (“LNAs) are positioned between receive antennas 310-314 and PS circuits 320-324, which include PSs similar to the PSs in PS circuits 316-318. For receive operation, PS circuits 310-324 create phase differentials between radiating elements in the receive antennas 310-314 to compensate for the time delay of received signals between radiating elements due to spatial configurations. Receive phase-shifting, also referred to as analog beamforming, combines the received signals for aligning echoes to identify the location, or position of a detected object. That is, phase shifting aligns the received signals that arrive at different times at each of the radiating elements in receive antennas 310-314. Similar to PS circuits 316-318 on the transmit chain, PS circuits 320-324 are controlled by FPGA 326, which provides the voltages to each PS to generate the desired phase shift. FPGA 326 also provides bias voltages to the LNAs 338-342.

The receive chain then combines the signals received at receive antennas 312 at combination network 344, from which the combined signals propagate to the transceiver 306. Note that as illustrated, combination network 344 generates two combined signals 346-348, with each signal combining signals from a number of elements in the receive antennas 312. In one example, receive antennas 312 include 48 radiating elements and each combined signal 346-348 combines signals received by 24 of the 48 elements. Other examples may include 8, 16, 24, 32, and so on, depending on the desired configuration. The higher the number of antenna elements, the narrower the beam width.

Note also that the signals received at receive antennas 310 and 314 go directly from PS circuits 320 and 324 to the transceiver 306. Receive antennas 310 and 314 are guard antennas that generate a radiation pattern separate from the main beams received by the 48-element receive antenna 312. Guard antennas 310 and 314 are implemented to effectively eliminate side-lobe returns from objects. The goal is for the guard antennas 310 and 314 to provide a gain that is higher than the side lobes and therefore enable their elimination or reduce their presence significantly. Guard antennas 310 and 314 effectively act as a side lobe filter.

Once the received signals are received by transceiver 306, they are processed by processing engines 350. Processing engines 350 include perception engine 304 which detects and identifies objects in the received signal with neural network and artificial intelligence techniques, database 352 to store historical and other information for radar 300, and a Digital Signal Processing (“DSP”) engine 354 with an Analog-to-Digital Converter (“ADC”) module to convert the analog signals from transceiver 306 into digital signals that can be processed to determine angles of arrival and other valuable information for the detection and identification of objects by perception engine 304. In one or more implementations, DSP engine 354 may be integrated with the microcontroller 338 or the transceiver 306.

Radar 300 also includes a Graphical User Interface (“GUI”) 358 to enable configuration of scan parameters such as the total angle of the scanned area defining the FoV, the beam width or the scan angle of each incremental transmission beam, the number of chirps in the radar signal, the chirp time, the chirp slope, the chirp segment time, and so on as desired. In addition, radar 300 has a temperature sensor 360 for sensing the temperature around the vehicle so that the proper voltages from FPGA 326 may be used to generate the desired phase shifts. The voltages stored in FPGA 326 are determined during calibration of the antennas under different operating conditions, including temperature conditions. A database 362 may also be used in radar 300 to store radar and other useful data.

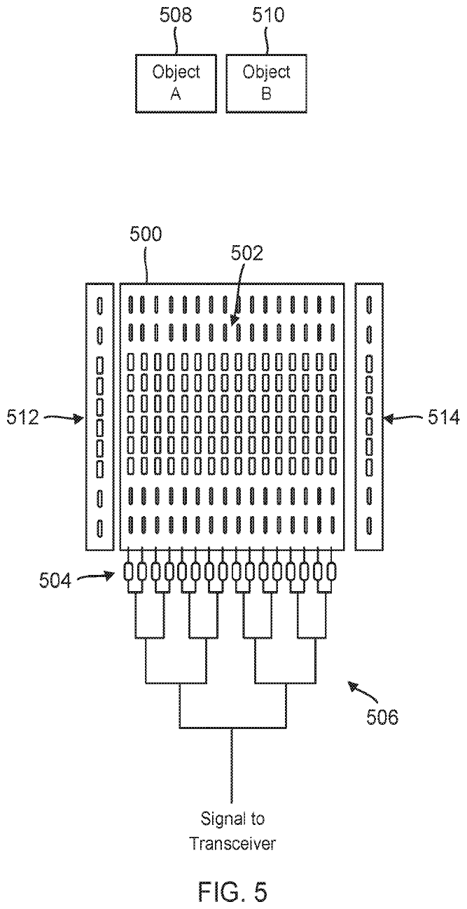

Attention is now directed to FIG. 5, which shows the antenna elements of the receive and guard antennas of FIG. 3 in more detail. Receive antenna 500 has a number of radiating elements 502 creating receive paths for signals or reflections from an object at a slightly different time. In various implementations, the radiating elements 502 are meta-structures or patches in an array configuration such as in a 48-element antenna. The phase and amplification modules 504 provide phase shifting to align the signals in time. The radiating elements 502 are coupled to the combination structure 506 and to phase and amplification modules 504, including phase shifters and LNAs implemented as PS circuits 320-324 and LNAs 338-342 of FIG. 3. In the present illustration, two objects, object A 508 and object B 510, are located at a same range and having a same velocity with respect to the antenna 500. When the distance between the objects is less than the bandwidth of a radiation beam, the objects may be indistinguishable by the system. This is referred to as angular resolution or spatial resolution. In the radar and object detection fields, the angular resolution describes the radar's ability to distinguish between objects positioned proximate each other, wherein proximate location is generally measured by the range from an object detection mechanism, such as a radar antenna, to the objects and the velocity of the objects.

Radar angular resolution is the minimum distance between two equally large targets at the same range which the radar can distinguish and separate. The angular resolution is a function of the antenna's half-power beam width, referred to as the 3 dB beam width and serves as limiting factor to object differentiation. Distinguishing objects is based on accurately identifying the angle of arrival of reflections from the objects. Smaller beam width angles result in high directivity and more refined angular resolution but requires faster scanning to achieve the smaller step sizes. For example, in autonomous vehicle applications, the radar is tasked with scanning an environment of the vehicle within a sufficient time period for the vehicle to take corrective action when needed. This limits the capability of a system to specific steps. This means that any object having a distance therebetween less than the 3 dB angle beam width cannot be distinguished without additional processing. Put another way, two identical targets at the same distance are resolved in angle if they are separated by more than the antenna 3 dB beam width. The present examples use the multiple guard band antennas to distinguish between the objects.

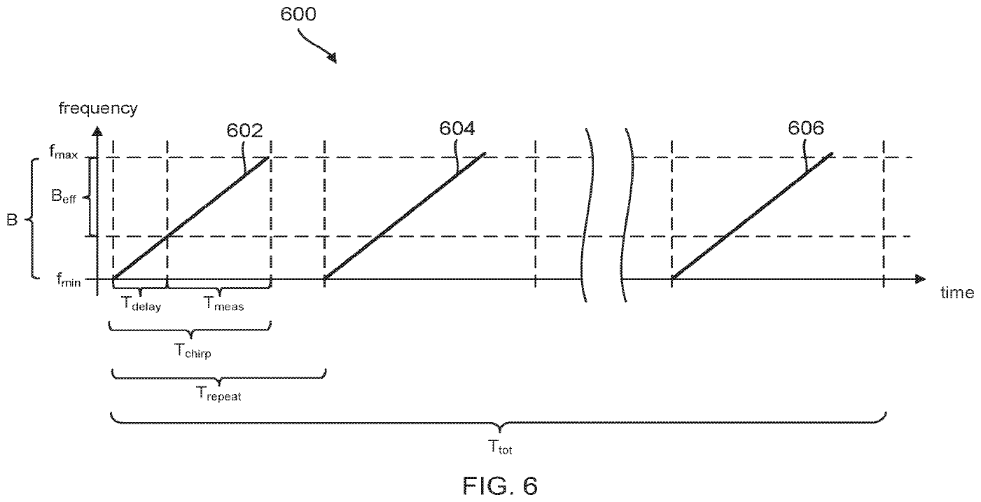

FIG. 6 illustrates a radar signal and its associated scan parameters in more detail. Radar signal 600 is an FMCW signal containing a series of chirps, such as chirps 602-606. Radar signal 600 is defined by a set of parameters that impact how to determine an object's location, its resolution, and velocity. The parameters associated with the radar signal 600 and illustrated in FIG. 6 include the following: (1) fₘₐₓ and fₘᵢₙ for the minimum and maximum frequency of the chirp signal; (2) Tₜₒₜₐₗ for the total time for one chirp sequence; (3) T_{delay} representing the settling time for a Phase Locked Loop (“PLL”) in the radar system; (4) Tₘₑₐₛ for the actual measurement time (e.g., >2 μs for a chirp sequence to detect objects within 300 meters); (5) T_{chip} for the total time of one chirp; (6) B for the total bandwidth of the chirp; (7) B_{eff} for the effective bandwidth of the chirp; (8) ΔB_{eff} for the bandwidth between consecutive measurements; (9) Nᵣ for the number of measurements taken per chirp (i.e., for each chirp, how many measurements will be taken of echoes); and (10) N_{c}, the number of chirps.

The distance and distance resolution of an object are fully determined by the chirp parameters Nᵣ and B_{eff}. In some aspects, the range resolution can be expressed as follows:

$$Δ R = \frac{c}{2 {B}_{eff}} ∝ \frac{1}{{B}_{eff}} \qquad ( Eq . 1 )$$

In some aspects, the maximum distance (or range) can be expressed as follows:

$${R}_{m ax} = \frac{c}{4 {B}_{eff}} {N}_{r} ∝ \frac{1}{Δ {B}_{eff}} \qquad ( Eq . 2 )$$

The velocity and velocity resolution of an object are fully determined by chirp sequence parameters (Nₑ, T_{chirp}) and frequency (fₘᵢₙ). The minimum velocity (or velocity resolution) achieved is determined as follows (with c denoting the speed of light):

$${v}_{m i n} = Δ v = \frac{c}{2 {f}_{c}} \frac{1}{{N}_{S} {T}_{chirp}} ∝ \frac{1}{{T}_{tot}} \qquad ( Eq . 3 )$$

Note that higher radar frequencies result in a better velocity resolution for the same sequence parameters. The maximum velocity is given by:

$${v}_{ma x} = \frac{c}{4 {f}_{c}} \frac{1}{{T}_{chirp}} ∝ \frac{1}{{T}_{chirp}} ∝ \frac{Δ R}{{R}_{ma x}} \qquad ( Eq . 4 )$$

Additional relationships between the scan parameters are given by the following equations, with Eq. 5 denoting the chirp slope κ_{chirp}, and Eq. 6 denoting the sample frequency:

$${κ}_{chirp} = \frac{{B}_{eff}}{{T}_{chirp}} \qquad ( Eq . 5 )$$

$${f}_{sample} ∝ {κ}_{chirp} * {R}_{m ax} \qquad ( Eq . 6 )$$

In various aspects, the sample frequency is a fixed. Also, the sample rate fₛₐₘₚₗₑ in Eq. 6 determines how fine a range resolution can be achieved for a selected maximum velocity and selected maximum range. In some aspects, the maximum range Rₘₐₓ may be defined by a user configuration depending on the type of environment (or type of path) detected. Note that once the maximum range Rₘₐₓ is fixed, vₘₐₓ and ΔR are no longer independent. One chirp sequence or segment has multiple chirps. Each chirp is sampled multiple times to give multiple range measurements and measure doppler velocity accurately. Each chirp may be defined by its slope, κ_{chirp}. The maximum range requirement may be inversely proportional to effective bandwidth of the chirp B_{eff} as indicated in Eq. 1, where an increase in the B_{eff} parameter can achieve an improved range resolution (or decreased range resolution value). The decreased range resolution value may be useful for object classification in a city street environment, where objects are moving at a significantly lower velocity compared to the highway environment so an improvement in the range resolution parameter value is more desirable than observing a degradation in the maximum velocity parameter. Similarly, the maximum velocity capability of a radar may be inversely proportional to the chirp time T_{chirp} as indicated in Eq. 4, where a decrease in the T_{chirp} parameter can achieve an improved maximum velocity (or increased maximum velocity value). The increased maximum velocity may be useful for object detection in a highway environment, where objects are moving at a significantly higher velocity compared to the city street environment so an improvement in the maximum velocity parameter is more desirable than observing a degradation in the range resolution parameter.

Note also that Eqs. 1-6 above can be used to establish scan parameters for given design goals. For example, to detect objects at high resolution at long ranges, the radar system 300 needs to take a large number of measurements per chirp. If the goal is to detect objects at high speed at a long range, the chirp time has to be low, limiting the chirp time. In the first case, high resolution detection at long range is limited by the bandwidth of the signal processing unit in the radar system. And in the second case, high maximum velocity at long range is limited by the data acquisition speed of the radar chipset (which also limits resolution).

In a selective scanning mode, the radar 300 adjusts its chirp slope to scan around an angle of interest rather than performing a full scan. This situation is encountered, for example, when the vehicle is faced with a curved road or highway as illustrated in FIG. 4. Radar 300 applies active localization and mapping to focus its scan to a shorter range around the area of interest. Similarly in other use cases, the active localization and mapping can be used to detect a change in the path and/or surrounding environment, such as a city street environment or a highway environment, where the maximum range needed for object detection may vary depending on the detected environment (or path). For example, mapping and location data may be used to trigger the selective scanning mode of operation of the radar 300 to focus the beam steering for a reduced range with higher range resolution (albeit with a smaller maximum velocity) in a city street environment or focus the beam steering for an increased range with higher maximum velocity (albeit with a smaller range resolution) in a highway environment. In adjusting its chirp slope for a city street environment, the radar 300 can perform object detection and classification using a smaller range maximum requirement in order to reduce its range resolution parameter value for improved detection and classification of objects in city streets. With the range maximum decreased for a city street environment, the chirp slope is adjusted to maintain the equilibrium with the fixed sample frequency as indicated by Eq. 6. To improve the range resolution for the city street environment, the effective bandwidth parameter B_{eff} and the chirp time parameter T_{chirp} are increased. As such, the chirp slope value is increased as indicated by Eq. 5. In adjusting its chirp slope for a highway environment, the radar 300 can perform object detection and classification using a higher range maximum requirement in order to increase its maximum velocity parameter value for improved detection and classification of objects in a highway at greater ranges (e.g., at or greater than 300 m). With the range maximum increased for a highway environment, the chirp slope is adjusted to maintain the equilibrium with the fixed sample frequency as indicated by Eq. 6. To improve the maximum velocity for the highway environment, the effective bandwidth parameter B_{eff} and the chirp time parameter T_{chirp} are decreased. As such, the chirp slope value is decreased as indicated by Eq. 5.

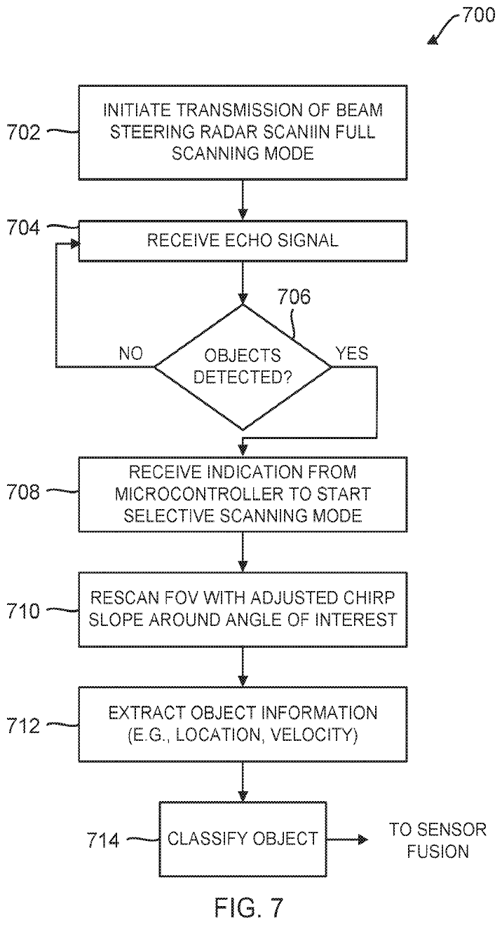

FIG. 7 is a flowchart of an example process 700 for operating a beam steering radar in an adjustable long-range mode in accordance with various examples. First, the radar initiates transmission of a beam steering scan in full scanning mode (702). Once an echo is received (704), the radar may detect objects (706) and/or receive an indication from the microcontroller 338 to start scanning in the selective mode (708).

The indication may be at the direction of perception engine 304 or from a mapping unit or other such engine (not shown) in the vehicle that detects a curved road. The indication from the microcontroller instructs the radar to adjust its chirp slope so that it scans an FoV area around an angle of interest, e.g., around the angle of the curved road (710). The chirp slope may be increased to focus on shorter ranges around the curve and achieve better resolution. Objects in the area of interest are then detected and their information is extracted (712) so that they can be classified (714) by the perception engine 304 into vehicles, cyclists, pedestrians, infrastructure objects, animals, and so forth. The object classification is sent to a sensor fusion module, where it is analyzed together with object detection information from other sensors such as lidar and camera sensors. The radar 300 continues its scanning process under the direction of the microcontroller 338, which instructs the radar on when to leave the selective scanning mode and return to the full scanning mode and on which scan parameters to use during scanning (e.g., chirp slope, beam width, etc.).

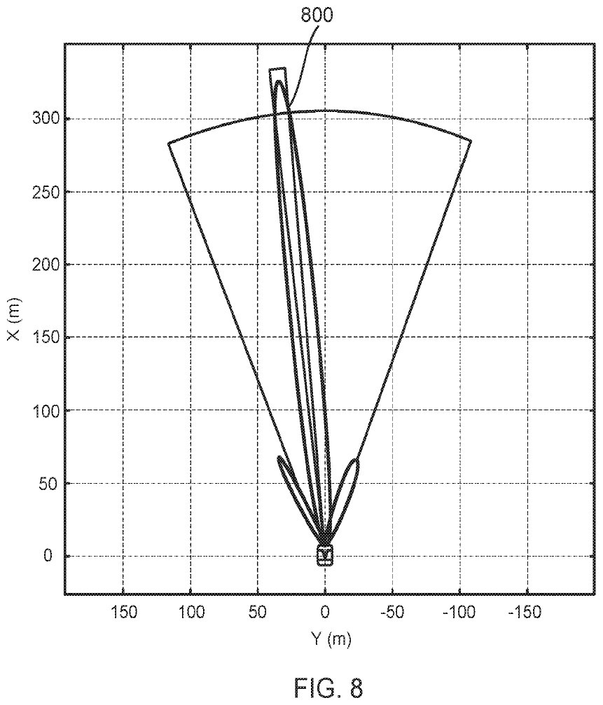

FIG. 8 illustrates an example radar beam that is transmitted by the radar 300 with a narrow main beam 800 capable to reach a long range of 300 m or more and side lobes that may be reduced with the guard antennas 310 and 314 and with DSP processing in the DSP module 356 of FIG. 3. This radar beam can be steered to any angle within the FoV to enable the radar 300 to detect and classify objects. The scanning mode can be changed depending on the road conditions (e.g., whether curved or not, whether city street or highway), environmental conditions and so forth. The beams are dynamically controlled and their parameters can be adjusted as needed under the instruction of the microcontroller 338 and perception engine 304.

These various examples support autonomous driving with improved sensor performance, all-weather/all-condition detection, advanced decision-making algorithms and interaction with other sensors through sensor fusion. These configurations optimize the use of radar sensors, as radar is not inhibited by weather conditions in many applications, such as for self-driving cars. The radar described here is effectively a “digital eye,” having true 3D vision and capable of human-like interpretation of the world.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A beam steering radar for use in an autonomous vehicle, comprising:
a radar module, comprising:
at least one beam steering antenna;
a transceiver; and
a controller configured to cause the transceiver to perform, using the at least one beam steering antenna, a first scan of a first field-of-view (FoV) with a first chirp slope in a first radio frequency (RF) signal and a second scan of a second FoV different from the first FoV with a second chirp slope different from the first chirp slope in a second RF signal; and
a perception module comprising a machine learning-trained classifier configured to detect one or more objects in a path and surrounding environment of the autonomous vehicle based on the first chirp slope in the first RF signal and classify the one or more objects based on the second chirp slope in the second RF signal, wherein the perception module is configured to transmit object data and radar control information to the radar module.

2. The beam steering radar of claim 1, wherein the controller is further configured to:
determine a range resolution of the one or more objects from the object data, wherein the range resolution is inversely proportional to an effective bandwidth of a chirp, and
determine a maximum velocity of the one or more objects from the object data, wherein the maximum velocity is inversely proportional to a chirp time of a chirp.

3. The beam steering radar of claim 1, wherein the second chirp slope is greater than the first chirp slope.

4. The beam steering radar of claim 3, wherein the controller is further configured to obtain a first range resolution of the one or more objects from the object data that corresponds to the first chirp slope in the first RF signal and obtain a second range resolution lesser than the first range resolution of the one or more objects from the object data that corresponds to the second chirp slope in the second RF signal.

5. The beam steering radar of claim 3, wherein the controller is further configured to determine a first maximum velocity of the one or more objects from the object data that corresponds to the first chirp slope in the first RF signal and determine a second maximum velocity lesser than the first maximum velocity of the one or more objects from the object data that corresponds to the second chirp slope in the second RF signal.

6. The beam steering radar of claim 1, wherein the controller is further configured to cause the transceiver to transmit, using the at least one beam steering antenna, the first RF signal having a first number of chirps at the first chirp slope to scan the first FoV up to a first range and transmit, using the at least one beam steering antenna, the second RF signal having a second number of chirps at the second chirp slope to scan the second FoV up to a second range different from the first range.

7. The beam steering radar of claim 6, wherein:
the second chirp slope is greater than the first chirp slope, and
the second range is lesser than the first range.

8. The beam steering radar of claim 1, wherein the perception module is further configured to send an indication to the radar module that causes the radar module to activate a selective scanning mode of the beam steering radar, and wherein the controller causes the transceiver to adjust a chirp slope of a transmission beam by adjusting from the first chirp slope to the second chirp slope.

9. The beam steering radar of claim 8, wherein the perception module is further configured to detect a change in the path based at least in part on the object data, and wherein the perception module is configured to generate the indication in response to detecting the change in the path.

10. The beam steering radar of claim 8, wherein the chirp slope is defined by a ratio of an effective bandwidth of one or more chirps in the transmission beam to a chirp time of the one or more chirps in the transmission beam.

11. The beam steering radar of claim 1, wherein the controller is further configured to cause the transceiver to perform the first scan and the second scan based on a set of scan parameters that is adjustable to produce a plurality of transmission beams through the at least one beam steering antenna.

12. The beam steering radar of claim 11, wherein the set of scan parameters includes one or more of a total angle of a scan area defining the FoV, a beam width of each of the plurality of transmission beams, a scan angle of each of the plurality of transmission beams, indication of the first chirp slope in the first RF signal, indication of the second chirp slope in the second RF signal, a chirp time, a chirp segment time, or a number of chirps.

13. A method of object detection and classification, comprising:
transmitting, at a transceiver using at least one beam steering antenna, a first transmission beam comprising a first chirp slope in a first field-of-view (FoV) at a first time;
receiving, at the transceiver through the at least one beam steering antenna, a first reflected signal associated with the first transmission beam;
detecting, using a perception module, an object in a path and surrounding environment from the first reflected signal based on the first chirp slope in the first transmission beam;
transmitting, at the transceiver using the at least one beam steering antenna, a second transmission beam comprising a second chirp slope greater than the first chirp slope in a second FoV different from the first FoV at a second time subsequent to the first time; and
classifying, using the perception module, the object from a second reflected signal associated with the second transmission beam based on the second chirp slope in the second transmission beam.

14. The method of claim 13, wherein:
the transmitting the first transmission beam comprises transmitting, using the at least one beam steering antenna, the first transmission beam having a first number of chirps at the first chirp slope to scan the first FoV up to a first range, and
the transmitting the second transmission beam comprises transmitting, using the at least one beam steering antenna, the second transmission beam having a second number of chirps at the second chirp slope to scan the second FoV up to a second range different from the first range.

15. The method of claim 14, wherein:
the second chirp slope is greater than the first chirp slope, and
the second range is lesser than the first range.

16. The method of claim 13, further comprising:
sending, using the perception module, an indication to a controller that causes the transceiver to activate a selective scanning mode of the transceiver; and
adjusting, at the transceiver, a chirp slope of a transmission beam by adjusting from the first chirp slope to the second chirp slope.

17. The method of claim 16, wherein the detecting the object comprises detecting, using the perception module, a change in the path based at least in part on object data acquired with the detecting, further comprising generating, using the perception module, the indication in response to detecting the change in the path.

18. The method of claim 13, wherein:
the transmitting the first transmission beam comprises performing a first scan in a first range of angles that corresponds to the first FoV based on the first chirp slope in the first transmission beam, and
the transmitting the second transmission beam comprises performing a second scan in a second range of angles different from the first range of angles that corresponds to the second FoV based on the second chirp slope in the second transmission beam.

19. An autonomous driving system, comprising:
a non-transitory memory; and
one or more hardware processors coupled to the non-transitory memory and configured to execute instructions from the non-transitory memory to cause the autonomous driving system to perform operations comprising:
performing a first scan of a first field-of-view (FoV) up to a first range using a first chirp slope in a first transmission beam;
detecting an object in a first received reflected signal based on the first chirp slope in the first transmission beam;
performing a second scan of a second FoV different from the first FoV up to a second range different from the first range using a second chirp slope greater than the first chirp slope in a second transmission beam; and
classifying the object from a second received reflected signal associated with the second transmission beam based on the second chirp slope in the second transmission beam.

20. The autonomous driving system of claim 19, wherein:
the second chirp slope is greater than the first chirp slope,
the second range is lesser than the first range, and
the first FoV corresponds to a first range of angles of interest and the second FoV corresponds to a second range of angles of interest different from the first range of angles of interest.
